(19) United States
(12) Patent Application Publication
(10) Pub. No.: US 2025/0075842 A1
(43) Pub. Date: Mar. 6, 2025

(54) COATED EXHAUST INSULATION SYSTEM AND METHOD

(71) Applicant: Lincoln Industries, Inc., Lincoln, NE (US)

(72) Inventors: Adam James Matzner, Lincoln, NE (US); John Michael Jarecki, Lincoln, NE (US)

(21) Appl. No.: 18/816,767

(22) Filed: Aug. 27, 2024

Related U.S. Application Data
(60) Provisional application No. 63/579,709, filed on Aug. 30, 2023.

(51) Int. Cl. F16L 59/147

(52) U.S. Cl. CPC F16L 59/147

(57) ABSTRACT

Exhaust insulation systems and methods are described that include a base insulation layer of an insulation disposed about a section of a workpiece such as an exhaust pipe. Exhaust insulation systems and methods are described that further include a middle retaining layer at least partially surrounding the base insulation layer, and a conformal polymer outer coating forming a direct interface with the middle retaining layer.

### CLAIM OF PRIORITY

This patent application claims the benefit of priority, under 35 U.S.C. § 119(e), to U.S. Provisional Patent Application Ser. No. 63/579,709, entitled “COATED EXHAUST INSULATION SYSTEM AND METHOD,” filed on Aug. 30, 2023, which is hereby incorporated by reference herein in its entirety.

### TECHNICAL FIELD

Various embodiments described herein relate to insulation systems. One specific example includes exhaust pipe insulation systems.

### BACKGROUND

Insulation systems can be used to retain heat or cold within an enclosure. Insulation systems can also be used for safety to protect users from a hot region of equipment. In selected insulation systems, multiple material layers are used, wherein each layer serves a different purpose. Improved exhaust insulation systems are desired.

### BRIEF DESCRIPTION OF THE DRAWINGS

FIG. 1A shows an exhaust insulation system.

FIG. 1B shows a cross section of the exhaust insulation system from FIG. 1A.

FIG. 2 shows a cross section of an exhaust insulation system according to an embodiment.

FIG. 3 shows another cross section of an exhaust insulation system according to an embodiment.

FIG. 4 shows a close-up cross section of a portion of an exhaust insulation system according to an embodiment.

FIG. 5 shows a close-up cross section of a portion of an exhaust insulation system according to an embodiment.

FIG. 6 shows an exhaust insulation system according to an embodiment.

FIG. 7 shows a flow diagram of a method of insulating an exhaust pipe according to an embodiment.

FIG. 8 shows another flow diagram of a method of insulating an exhaust pipe according to an embodiment.

### DETAILED DESCRIPTION

In the following detailed description of the invention, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized, and structural, logical, and electrical changes may be made.

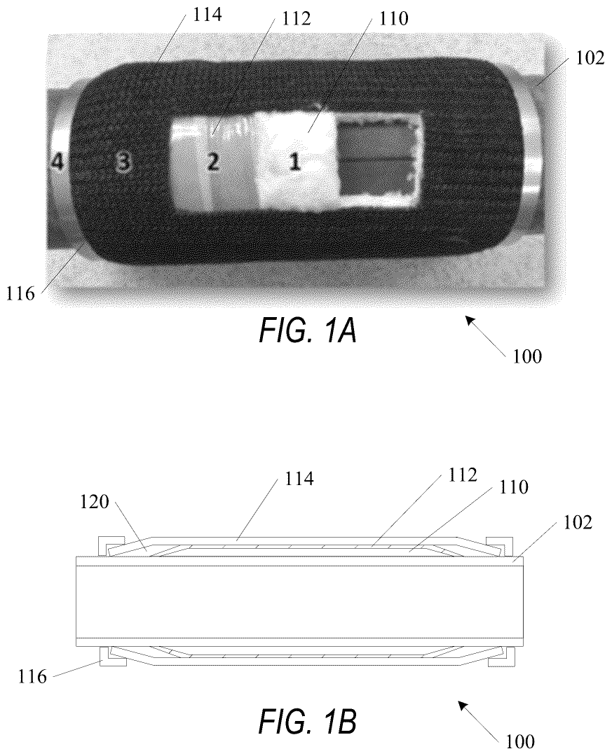

FIG. 1A shows an example of an exhaust insulation system 100. The system 100 is shown over an exhaust pipe section 102. The exhaust insulation system 100 includes a base insulation layer 110. FIG. 1A further shows a retaining layer 112 at least partially surrounding the base insulation layer 110. In one example, as can be seen in FIG. 1A, the retaining layer 112 includes a band of polyimide wrapped spirally around the base insulation layer 110. FIG. 1A further shows an outer fabric layer 114. In one example the outer fabric layer 114 is impregnated with a resin. FIG. 1A further shows one or more retaining bands 116 located on one or more ends of an insulated portion.

FIG. 1B shows a cross section of the exhaust insulation system 100 from FIG. 1A. In a manufacturing operation, of the exhaust insulation system 100, the base insulation layer 110 is wrapped with the retaining layer 112. The outer fabric layer 114 is then slid over the wrapped base insulation layer 110, by sliding a sleeve of outer fabric layer 114 over the wrapped base insulation layer 110 from one side or the other. Because the outer fabric layer 114 is a separate component that is placed over the wrapped base insulation layer 110, gaps 120 may occur where the outer fabric layer 114 encounters surface features that protrude. For example, in FIG. 1A, the gap 120 illustrated can form due to differences in thickness of adjacent structures such as the thickness of the wrapped base insulation layer 110. It is desirable to reduce or eliminate gaps 120 to provide improved mechanical integrity of the exhaust insulation system 100.

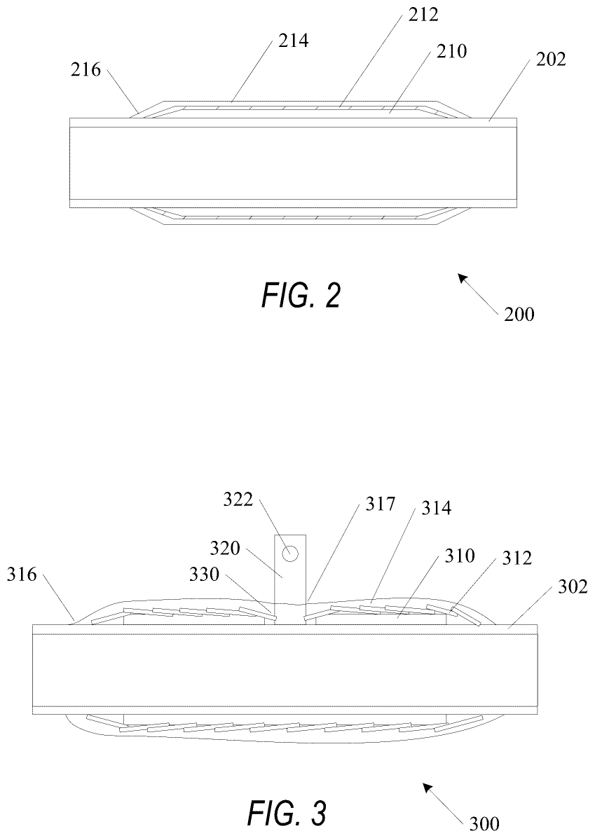

FIG. 2 shows an exhaust insulation system 200 according to one example. The exhaust insulation system 200 includes an exhaust pipe section 202. A base insulation layer 210 is shown in direct contact with the exhaust pipe section 202. In one example, the base insulation layer 210 includes a fiber mat insulation layer. In one example the fiber mat insulation layer includes substantially random fiber orientations within a plane of the mat. In one example the fiber mat insulation layer includes E-glass fibers. One advantage of fiber mat insulation layers includes additional space for trapped air, which increases an insulating property of the fiber mat insulation layer. Another advantage of a fiber mat insulation layer is cost. Fiber mat insulation layers are significantly less expensive than fabric insulation, which reduces an overall cost of the system 200. In one example using a fiber mat insulation layer as a base insulation layer 210, a thickness dimension is controlled, which provides a more even amount of thermal insulation. Although a fiber mat is used as an example base insulation layer 210, the invention is not so limited. Other examples of base insulation layer 210 include woven fabrics, foams, meshes, etc. Although a glass fiber material is used as an example, other examples include, but are not limited to, basalt fibers, carbon fibers, ceramic fibers, etc.

FIG. 2 further shows a middle retaining layer 212 over the base insulation layer 210. In one example, the middle retaining layer 212 includes a wrapped tape retaining layer. In one example, a wrapped tape retaining layer compresses the base insulation layer 210 by a selected percentage. In examples that include compression of the base insulation layer 210, a thickness of the base insulation layer 210 is more effectively controlled than with a bare insulation layer. For example, base insulation layer 210 may be compressed by about 40%-60% or more, depending on the application. In one example, the base insulation layer 210 has a thickness of about 0.75 inches when placed over an exhaust component and a thickness of 0.40 inches after being compressively wrapped by the polyimide layer. Additionally, by wrapping the base insulation layer 210, later processing steps in forming the system 200 are facilitated because, for example, the base insulation layer 210 is held firmly in place by the middle retaining layer 212 and the middle retaining layer 212 provides a smooth surface and firm base for an outer coating 214 discussed in more detail below.

In one example, the middle retaining layer 212 includes a polyimide tape. In one example, the middle retaining layer 212 includes a woven glass tape. In one example, the middle retaining layer 212 includes a polyester tape. Although polyimide and woven glass are used as examples, other materials such as other polymers, or foil materials may also be used within the scope of the invention. Polyimide can provide advantages in certain application over foil material by, for example, moisture resistance, its ease of installation by wrapping, its resistance to automotive chemicals, and its low cost.

An outer coating 214 is further shown covering the base insulation layer 210 and the middle retaining layer 212. In one example, the outer coating 214 includes a conformal polymer outer coating forming a direct interface with the middle retaining layer. In one example, the outer coating 214 is applied over the base insulation layer 210 and the middle retaining layer 212 using a fluid resin application process. In one example, fluid includes several viscosities over a range of flowability. One fluid resin application process includes spreading a more viscous resin using a tool such as an applicator or knife edge. In one example, a fluid resin application process includes spraying. Other fluid resin application processes include, but are not limited to, squirting, dipping, pouring, etc.

In contrast to assembling a pre-impregnated fabric or sleeve, using a fluid resin application process provides a number of advantages. A fluid resin application process will result in a different physical structure than an outer fabric layer 114 as shown and described in FIGS. 1A and 1B. An outer coating 214 formed by a fluid resin application process will be conformal to surface features and prior layers. For example, an outer coating 214 formed by a fluid resin application process will not include gaps such as gaps 120 as illustrated in FIG. 1B. In contrast to outer fabric layer 114 as shown and described in FIGS. 1A and 1B, outer coating 214 formed by a fluid resin application process may include a taper 216 at edges where the outer coating 214 meets adjacent structures. In one example, due to surface tension during curing after spray application, outer coating 214 may include a concave taper 216 at edges where the outer coating 214 meets adjacent structures.

One advantage of an outer coating 214 formed by a fluid resin application process with physical features as described above includes increased mechanical strength. Features such as the taper 216 provide better adhesion and resistance to peeling. A lack of gaps 120 provides resistance to spalling or delaminating. Manufacture of the exhaust insulation system 200 with the outer coating 214 formed by a fluid resin application process is also simplified over the outer fabric layer configuration shown in FIG. 1A and 1B, making manufacturing costs lower.

In one example, the outer coating 214 includes a silicone polymer. In one example, the outer coating 214 includes a phenolic polymer. Other polymers applied by fluid resin coating are also within the scope of the invention. An advantage of silicone and phenolic include ease of spraying, and low heat conductivity which provides better thermal insulation.

FIG. 3 shows another example of an exhaust insulation system 300 according to one example. The exhaust insulation system 300 includes an exhaust pipe section 302. Similar to the example of FIG. 2, a base insulation layer 310 is shown in direct contact with the exhaust pipe section 302. FIG. 3 further shows a middle retaining layer 312 over the base insulation layer 310. Similar to the example of FIG. 2, the middle retaining layer 312 includes a wrapped tape retaining layer, although the invention is not so limited. The exhaust insulation system 300 of FIG. 3 further includes an exhaust mounting bracket 320. A hole 322 is included for a fastener such as a mounting bolt (not shown). In the example of FIG. 3, the middle retaining layer 312 is wrapped around the exhaust mounting bracket 320, resulting in surface depressions 330 adjacent to the mounting bracket 320.

An outer coating 314 is shown covering the base insulation layer 310 and the middle retaining layer 312. In one example, the outer coating 314 includes a conformal polymer outer coating forming a direct interface with the middle retaining layer. In one example, the outer coating 314 is applied over the base insulation layer 310 and the middle retaining layer 312 using a fluid resin application process. As describe above, a fluid resin application process will result in a different physical structure than an outer fabric layer 114 as shown and described in FIGS. 1A and 1B. In addition to a taper 316 similar to the taper 216 shown in FIG. 2, the exhaust insulation system 300 of FIG. 3 shows how the outer coating 314 conforms around the surface depressions 330 adjacent to the mounting bracket 320. In one example, a taper similar to taper 316 will also be present at an interface between the mounting bracket 320 and the outer coating 314. In contrast to configurations with an outer fabric layer 114 as shown and described in FIGS. 1A and 1B, the outer coating 314 formed by a fluid resin application process will not have any gaps around the mounting bracket 320, and the outer coating 314 will completely seal against side surfaces of the mounting bracket 320.

Similar to the outer coating 214 from FIG. 2, the outer coating 314 of FIG. 3 includes physical features that provide increased mechanical strength. Features such as the taper 216 provide better adhesion and resistance to peeling. A lack of gaps 120 provides resistance to spalling or delaminating. Manufacture of the exhaust insulation system 300 with the outer coating 314 formed by a fluid resin application process is also simplified over the outer fabric layer configuration shown in FIGS. 1A and 1B, making manufacturing costs lower.

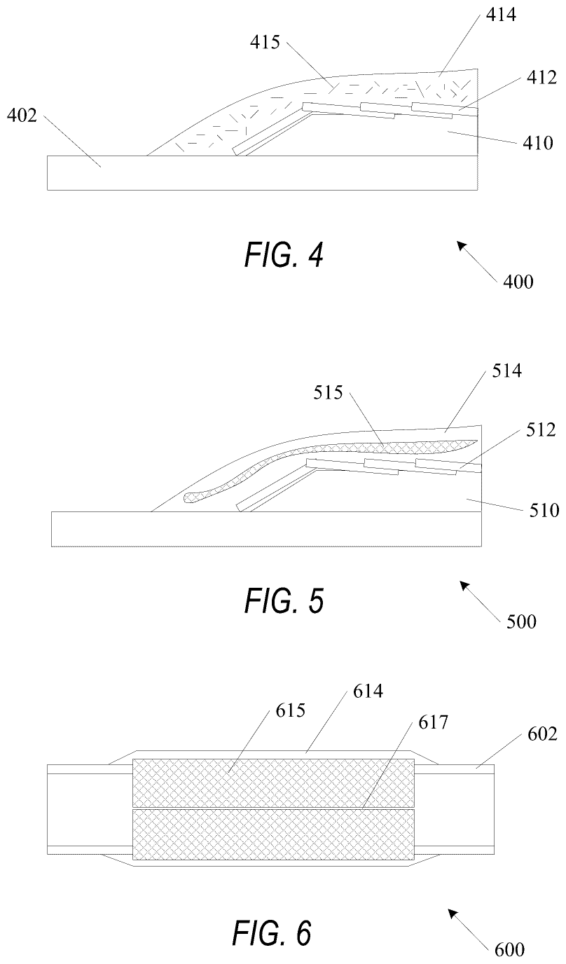

In one example, a reinforcing phase is included within the outer coating formed by a fluid resin application process. FIG. 4 shows an exhaust insulation system 400 including an exhaust pipe sidewall 402 in a closer view that FIGS. 2 and 3. A base insulation layer 410 is shown in direct contact with the exhaust pipe sidewall 402. FIG. 4 further shows a middle retaining layer 412 over the base insulation layer 410. Similar to the examples of FIGS. 2 and 3, the middle retaining layer 412 includes a wrapped tape retaining layer, although the invention is not so limited. An outer coating 414 is shown covering the base insulation layer 410 and the middle retaining layer 412. In one example, the outer coating 414 includes a conformal polymer outer coating forming a direct interface with the middle retaining layer. In one example, the outer coating 414 is applied over the base insulation layer 410 and the middle retaining layer 412 using a fluid resin application process. A reinforcing phase 415 is shown equally distributed throughout the conformal polymer outer coating 414.

In one example, the reinforcing phase 415 includes fibers. In one example, the fibers include glass fibers. In one example, the fibers include basalt fibers. In one example, the fibers include carbon fibers. In one example, the reinforcing phase 415 is co-sprayed with a resin to form the conformal polymer outer coating 414. The addition of a reinforcing phase 415 provides a number of advantages. In one example, the reinforcing phase 415 aids in adhering the resin of the conformal polymer outer coating 414 to the underlying components such as the middle retaining layer 412, the exhaust pipe sidewall 402, and any mounting brackets. The reinforcing phase 415 may modify a viscosity of a resin to promote adhesion during a curing time. The reinforcing phase 415 also improves mechanical strength of a cured conformal polymer outer coating 414.

FIG. 5 shows another example of an exhaust insulation system 500 including an exhaust pipe sidewall 502. A base insulation layer 510 is shown in direct contact with the exhaust pipe sidewall 502. FIG. 5 further shows a middle retaining layer 512 over the base insulation layer 510. Similar to the examples of FIGS. 2 and 3, the middle retaining layer 512 includes a wrapped tape retaining layer, although the invention is not so limited. An outer coating 514 is shown covering the base insulation layer 510 and the middle retaining layer 512. In one example, the outer coating 514 includes a conformal polymer outer coating forming a direct interface with the middle retaining layer. In one example, the outer coating 514 is applied over the base insulation layer 510 and the middle retaining layer 512 using a fluid resin application process. A reinforcing phase 515 is shown at least partially encapsulated in the conformal polymer outer coating 514. In one example, the reinforcing phase 515 includes a sheet of fibers or filaments. In one example, the reinforcing phase 515 includes a metal wire or metal mesh sheet.

Similar to the example of FIG. 4, the addition of reinforcing phase 515 provides a number of advantages. In one example, the reinforcing phase 515 aids in adhering the resin of the conformal polymer outer coating 514 to the underlying components such as the middle retaining layer 512, the exhaust pipe sidewall 502, and any mounting brackets. The reinforcing phase 515 may hold amounts of resin using surface tension to promote adhesion during a curing time. The reinforcing phase 515 also improves mechanical strength of a cured conformal polymer outer coating 514.

FIG. 6 shows another example of an exhaust insulation system 600 including an exhaust pipe section 602. A reinforcing phase 615 is shown similar to the reinforcing phase 515 from FIG. 5. In the view of FIG. 6, a seam 617 in the reinforcing phase 515 is shown. The reinforcing phase 615 is further shown at least partially encapsulated in a conformal polymer outer coating 614. In one example, a sheet of reinforcing phase 615 is wrapped around the exhaust pipe section 602, then the conformal polymer outer coating 614 is applied in fluid form over the reinforcing phase 615. In one example, force is used to conform the reinforcing phase 615 to the exhaust pipe section 602. In one example, a strip of reinforcing phase 615 is spirally wrapped around the exhaust pipe section 602, and tension is applied during wrapping to help the strip of reinforcing phase 615 conform to the exhaust pipe section 602. After wrapping, the conformal polymer outer coating 614 is applied in fluid form over the spiral wrapped reinforcing phase 615. A spiral wrapped reinforcing phase 615 will also include a seam, however, the seam will be spiral along edges of the strip of reinforcing phase 615.

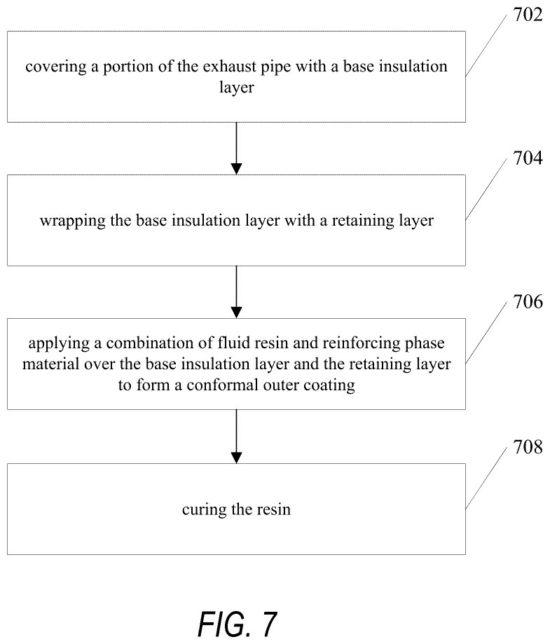

FIG. 7 shows one example of a flow diagram of a method of manufacture of an exhaust insulation system. In operation 702, a portion of the exhaust pipe is covered with a base insulation layer. In operation 704, the base insulation layer is wrapped with a retaining layer. In operation 706, a combination of fluid resin and reinforcing phase material is applied over the base insulation layer and the retaining layer to form a conformal outer coating, and in operation 708, the resin is cured.

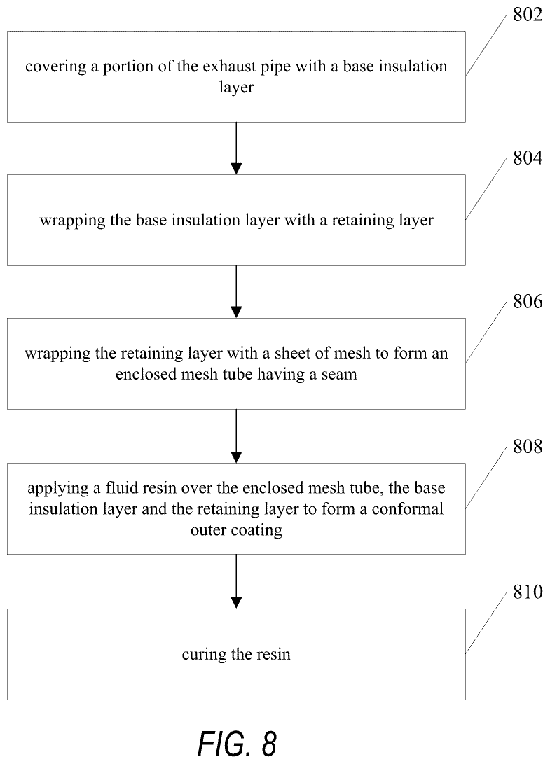

FIG. 8 shows another example of a flow diagram of a method of manufacture of an exhaust insulation system. In operation 802, a portion of the exhaust pipe is covered with a base insulation layer. In operation 804, the base insulation layer is wrapped with a retaining layer. In operation 806, the retaining layer is wrapped with a sheet of mesh to form an enclosed mesh tube having a seam. In operation 808, a fluid resin is applied over the enclosed mesh tube, the base insulation layer and the retaining layer to form a conformal outer coating, and in operation 810, the resin is cured.

To better illustrate the method and apparatuses disclosed herein, a non-limiting list of embodiments is provided here:

Example 1 is an exhaust insulation system for an exhaust pipe. The exhaust insulation system includes a base insulation layer of an insulation disposed about a section of the exhaust pipe, a middle retaining layer at least partially surrounding the base insulation layer, and a conformal polymer outer coating forming a direct interface with the middle retaining layer.

Example 2 includes the exhaust insulation system of Example 1, wherein the conformal polymer outer coating includes a silicone conformal outer coating.

Example 3 includes the exhaust insulation system of any one of Examples 1-2, wherein the conformal polymer outer coating includes a phenolic conformal outer coating.

Example 4 includes the exhaust insulation system of any one of Examples 1-3, wherein the middle retaining layer includes a wrapped tape retaining layer.

Example 5 includes the exhaust insulation system of any one of Examples 1-4, wherein the tape includes polyimide.

Example 6 includes the exhaust insulation system of any one of Examples 1-5, wherein the tape includes a woven glass.

Example 7 is an exhaust insulation system for an exhaust pipe. The exhaust insulation system includes a base insulation layer of an insulation disposed about a section of the exhaust pipe, a middle retaining layer at least partially surrounding the base insulation layer, a conformal polymer outer coating forming a direct interface with the middle retaining layer, and a reinforcing phase equally distributed throughout the conformal polymer outer coating.

Example 8 includes the exhaust insulation system of Example 7, wherein the reinforcing phase includes fibers.

Example 9 includes the exhaust insulation system of any one of Examples 7-8, wherein the fibers are chosen from a fiber material including glass, carbon, and basalt fibers.

Example 10 includes the exhaust insulation system of any one of Examples 7-9, wherein the conformal polymer outer coating includes a silicone conformal outer coating.

Example 11 includes the exhaust insulation system of any one of Examples 7-10, wherein the conformal polymer outer coating includes a phenolic conformal outer coating.

Example 12 includes the exhaust insulation system of any one of Examples 7-11, wherein the middle retaining layer includes a wrapped tape retaining layer.

Example 13 includes the exhaust insulation system of any one of Examples 7-12, wherein the tape includes polyimide.

Example 14 includes the exhaust insulation system of any one of Examples 7-13, wherein the tape includes polyester.

Example 15 includes the exhaust insulation system of any one of Examples 7-14, wherein the tape includes a woven glass.

Example 16 includes the exhaust insulation system of any one of Examples 7-15, wherein the reinforcing phase includes a metal wire fabric.

Example 17 includes the exhaust insulation system of any one of Examples 7-16, wherein the reinforcing phase includes a metal mesh.

Example 18 includes the exhaust insulation system of any one of Examples 7-17, wherein the metal mesh includes a seam.

Example 19 includes a method of forming an exhaust insulation system. The method includes covering a portion of the exhaust pipe with a base insulation layer, wrapping the base insulation layer with a retaining layer, spraying a combination of resin and reinforcing phase material over the base insulation layer and the retaining layer to form a conformal outer coating, and curing the resin.

Example 20 includes the method of Example 19, wherein curing the resin includes curing a silicone resin.

Example 21 includes the method of any one of Examples 19-20, wherein spraying the combination of resin and reinforcing phase material includes spraying a combination of resin and a fiber reinforcing phase chosen from glass fiber, basalt fiber, and carbon fiber.

Example 22 includes the method of any one of Examples 19-21, further including compressing the base insulation layer with the retaining layer.

Example 23 includes the method of any one of Examples 19-22, wherein compressing the base insulation layer with the retaining layer includes wrapping the base insulation layer with a tape.

Example 24 includes the method of any one of Examples 19-23, wherein wrapping the base insulation layer with a tape includes wrapping with a polyimide tape.

Example 25 includes the method of any one of Examples 19-24, wherein wrapping the base insulation layer with a tape includes wrapping with a woven glass tape.

Example 26 includes a method of forming an exhaust insulation system. The method includes covering a portion of the exhaust pipe with a base insulation layer, wrapping the base insulation layer with a retaining layer, wrapping the base insulation layer with a retaining layer, wrapping the retaining layer with a sheet of mesh to form an enclosed mesh tube having a seam, spraying a resin over the enclosed mesh tube, the base insulation layer and the retaining layer to form a conformal outer coating, and curing the resin.

Example 27 includes the method of Example 26, wherein wrapping the retaining layer with a sheet of mesh includes wrapping with a metal mesh.

Example 28 includes the method of any one of Examples 26-27, wherein spraying a resin over the enclosed mesh tube includes spraying a silicone resin over the enclosed mesh tube.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An exhaust insulation system for an exhaust pipe, comprising:
a base insulation layer of an insulation disposed about a section of the exhaust pipe;
a middle retaining layer at least partially surrounding the base insulation layer; and
a conformal polymer outer coating forming a direct interface with the middle retaining layer.

2. The exhaust insulation system of claim 1, wherein the conformal polymer outer coating includes a silicone conformal outer coating.

3. The exhaust insulation system of claim 1, wherein the conformal polymer outer coating includes a phenolic conformal outer coating.

4. The exhaust insulation system of claim 1, wherein the middle retaining layer includes a wrapped tape retaining layer.

5. The exhaust insulation system of claim 4, wherein the tape includes polyimide.

6. The exhaust insulation system of claim 4, wherein the tape includes a woven glass.

7. An exhaust insulation system for an exhaust pipe, comprising:
a base insulation layer of an insulation disposed about a section of the exhaust pipe;
a middle retaining layer at least partially surrounding the base insulation layer;
a conformal polymer outer coating forming a direct interface with the middle retaining layer; and
a reinforcing phase equally distributed throughout the conformal polymer outer coating.

8. The exhaust insulation system of claim 7, wherein the reinforcing phase includes fibers.

9. The exhaust insulation system of claim 8, wherein the fibers are chosen from a fiber material including glass, carbon, and basalt fibers.

10. The exhaust insulation system of claim 7, wherein the conformal polymer outer coating includes a silicone conformal outer coating.

11. The exhaust insulation system of claim 7, wherein the conformal polymer outer coating includes a phenolic conformal outer coating.

12. The exhaust insulation system of claim 7, wherein the middle retaining layer includes a wrapped tape retaining layer.

13. The exhaust insulation system of claim 12, wherein the tape includes polyimide.

14. The exhaust insulation system of claim 12, wherein the tape includes polyester.

15. The exhaust insulation system of claim 12, wherein the tape includes a woven glass.

16. The exhaust insulation system of claim 7, wherein the reinforcing phase includes a metal mesh sheet.

17. The exhaust insulation system of claim 16, wherein the metal mesh sheet includes a seam.

18. The exhaust insulation system of claim 17, wherein the metal mesh sheet is spiral wrapped.

19. A method of forming an exhaust insulation system, comprising:
covering a portion of an exhaust pipe with a base insulation layer;
wrapping the base insulation layer with a retaining layer;
applying a combination of fluid resin and reinforcing phase material over the base insulation layer and the retaining layer to form a conformal outer coating; and
curing the resin.

20. The method of claim 19, wherein wrapping the base insulation layer with a retaining layer includes spiral wrapping.

21. The method of claim 20 further including applying tension while wrapping the retaining layer to conform the retaining layer to the exhaust pipe.

22. The method of claim 19, wherein applying the combination of fluid resin and reinforcing phase material includes spraying the fluid resin.

23. The method of claim 19, wherein curing the fluid resin includes curing a silicone resin.

24. The method of claim 19, wherein applying the combination of fluid resin and reinforcing phase material includes spraying a combination of fluid resin and a fiber reinforcing phase chosen from glass fiber, basalt fiber, and carbon fiber.

25. The method of claim 19, further including compressing the base insulation layer with the retaining layer.

26. The method of claim 25, wherein compressing the base insulation layer with the retaining layer includes wrapping the base insulation layer with a tape.

27. The method of claim 25, wherein wrapping the base insulation layer with a tape includes wrapping with a polyimide tape.

28. The method of claim 25, wherein wrapping the base insulation layer with a tape includes wrapping with a woven glass tape.

29. A method of forming an exhaust insulation system, comprising:
covering a portion of an exhaust pipe with a base insulation layer;
wrapping the base insulation layer with a retaining layer;
wrapping the retaining layer with a sheet of mesh to form an enclosed mesh tube having a seam;
applying a fluid resin over the enclosed mesh tube, the base insulation layer and the retaining layer to form a conformal outer coating; and
curing the resin.

30. The method of claim 29, wherein wrapping the retaining layer with a sheet of mesh includes wrapping with a metal mesh.

31. The method of claim 29, wherein spraying a resin over the enclosed mesh tube includes spraying a silicone resin over the enclosed mesh tube.
